(19) United States
(12) Patent Application Publication
(10) Pub. No.: US 2015/0304289 A1
(43) Pub. Date: Oct. 22, 2015

(54) NOTARIZATION AGENT AND METHOD FOR COLLECTING DIGITAL EVIDENCE USING NOTARIZATION AGENT

(71) Applicant: ELECTRONICS AND TELECOMMUNICATIONS RESEARCH INSTITUTE, Daejeon (KR)

(72) Inventors: Youngjun CHO, Daejeon (KR); SeongKu KANG, Daejeon (KR); Jaeduck CHOI, Daejeon (KR); Mincheol JEON, Daejeon (KR); Sinkyu KIM, Daejeon (KR); Jungtaek SEO, Daejeon (KR)

(73) Assignee: ELECTRONICS AND TELECOMMUNICATIONS RESEARCH INSTITUTE, Daejeon (KR)

(21) Appl. No.: 14/258,086

(22) Filed: Apr. 22, 2014

(51) Int. Cl. H04L 29/06; G06F 21/64

(52) U.S. Cl. CPC H04L 63/0471; H04L 63/061; G06F 21/645

(57) ABSTRACT

In a digital evidence collection method, an evidence collection device sends an evidence collection request message requesting permission of evidence collection to a notarization server through a notarization agent. The notarization server sends a collection permission message permitting evidence collection to the evidence collection device through the notarization agent. The evidence collection device requests evidence data from an evidence collection target system through the notarization agent. The evidence collection target system transmits the evidence data to the notarization agent. The notarization agent encrypts the evidence data and transfers encrypted evidence data to the evidence collection device.

### BACKGROUND OF THE INVENTION

1. Technical Field

The present invention relates generally to a digital evidence collection method using a notarization agent, which prevents the falsification or forgery of evidence that may occur upon collecting real-time digital evidence, thus guaranteeing the integrity, confidentiality, objectivity, and access control of digital evidence at that time of collection and, more particularly, to technology that creates a signature value for digital evidence using a reliable notarization agent at an evidence collection step, guarantees integrity using the signature value, encrypts information such as original data, collection time and place, and a collector, and guarantees confidentiality and objectivity until an analysis step, and that enables encrypted evidence data to be decrypted only at an analysis step and then performs access control.

2. Description of the Related Art

Digital evidence collection denotes the collection of data that may become evidence by ensuring objectivity, integrity, reliability, and originality necessary for providing legal validity from digital data that can be easily copied and that makes it difficult to distinguish original data from a copy due to the characteristics thereof.

Digital evidence collection is configured to create original digital data, to read data from the original digital data, and to create a copy including the same data, and is characterized in that evidence is analyzed based on the copy, and it is proved that the analyzed data is identical to the original data, thus ensuring the legitimacy of digital evidence.

Currently, when it is difficult to secure a storage medium corresponding to original digital evidence, or when volatile data evidence is collected, technology for guaranteeing the integrity of real-time evidence and a data copy by exploiting a method of storing hash values using timestamps or screen capturing has been utilized.

Korean Patent Application Publication No. 2011-0022140 discloses technology for securing the admissibility of evidence for data, the storage medium of which is difficult to acquire. However, the technology disclosed in the above patent is limited in that, when it is difficult to acquire a storage medium or when volatile data evidence is collected, if a malicious evidence collector forges or falsifies data desired to be collected and performs a procedure for proving the validity of evidence, or randomly creates digital evidence using a malicious evidence collection device, it is impossible to detect or block such forged or falsified data or randomly created evidence.

In order to solve the above problem, there has been a strong need to develop security technology for authenticating and encrypting digital evidence from a time, at which digital evidence is extracted from an evidence collection target, using a notarization agent, and guaranteeing confidentiality, objectivity, integrity, and access control, and thus blocking the intermediate intervention of an evidence collector or a device.

### SUMMARY OF THE INVENTION

Accordingly, the present invention has been made keeping in mind the above problems occurring in the prior art, and an object of the present invention is to block the intervention of an evidence collector and guarantee the integrity, confidentiality, and objectivity of evidence data, upon collecting digital evidence, by connecting a notarization agent between an evidence collection device and a target system.

In accordance with an aspect of the present invention to accomplish the above object, there is provided a digital evidence collection method, including sending, by an evidence collection device, an evidence collection request message requesting permission of evidence collection to a notarization server through a notarization agent, sending, by the notarization server, a collection permission message permitting evidence collection to the evidence collection device through the notarization agent, requesting, by the evidence collection device, evidence data from an evidence collection target system through the notarization agent, transmitting, by the evidence collection target system, the evidence data to the notarization agent, and encrypting, by the notarization agent, the evidence data and transferring, by the notarization agent, encrypted evidence data to the evidence collection device.

The evidence collection request message may include unique collection information of the evidence data, and the notarization server may generate a random key for the unique collection information, and transfer the random key together with the collection permission message to the notarization agent.

The notarization agent may encrypt the evidence data using the random key.

The evidence collection target system may partition the evidence data into data blocks of preset size and transmit the data blocks to the notarization agent, and the notarization agent generates primary hash values for the data blocks and stores the hash values.

The notarization agent may transfer the encrypted evidence data to the evidence collection device, generate secondary hash values for the primary hash values, create a signature value for the secondary hash values, and store the signature value.

The evidence collection target system may partition the evidence data into data blocks of preset size and transmit the data blocks to the notarization agent, and the notarization agent may encrypt the data blocks, transmit the encrypted data blocks to the evidence collection device, generate primary hash values for the encrypted data blocks, and store the primary hash values.

The notarization agent may transfer the encrypted evidence data to the evidence collection device, generate secondary hash values for the primary hash values, create a signature value for the secondary hash values, and store the signature value.

The digital evidence collection method may further include, before sending the evidence collection request message requesting permission of evidence collection, performing authentication between the evidence collection device, the notarization agent, and the notarization server.

In accordance with another aspect of the present invention to accomplish the above object, there is provided a notarization agent, including an authentication unit for performing authentication via comparison with authentication values of an evidence collection device and a notarization server, an evidence collection request unit for generating an evidence collection request message requesting permission of collection of evidence data, and an evidence collection unit for collecting evidence data from an evidence collection target system and encrypting the evidence data.

The evidence collection request message may include unique collection information of the evidence data, and the evidence collection unit may receive a random key for the unique collection information from the notarization server, and encrypt the evidence data using the random key.

The evidence collection unit may partition the evidence data into data blocks of preset size, collect the data blocks, generate primary hash values for the data blocks, and store the primary hash values.

The evidence collection unit may transfer the encrypted evidence data to the evidence collection device, generate secondary hash values for the primary hash values, create a signature value for the secondary hash values, and store the signature value.

The evidence collection unit may encrypt the data blocks, transmits encrypted data blocks to the evidence collection device, generate primary hash values for the encrypted data blocks, and store the primary hash values.

The evidence collection unit may transfer the encrypted evidence data to the evidence collection device, generate secondary hash values for the primary hash values, create a signature value for the secondary hash values, and store the signature value.

The notarization agent may further include a security key storage unit for storing a private key required to generate an authentication value, wherein the authentication unit generates the authentication value using the private key, compares the authentication value with an authentication value of the notarization server or the evidence collection device, and then performs authentication.

In accordance with a further aspect of the present invention to accomplish the above object, there is provided a digital evidence analysis method, including requesting, by an analysis system, analysis target data from an evidence collection device, transmitting, by the evidence collection device, unique collection information, a signature value, and encrypted evidence data to the analysis system, transferring, by the analysis system, the unique collection information to a notarization server, transferring, by the notarization sever, a random key corresponding to the unique collection information to the analysis system, decrypting, by the analysis system, the encrypted evidence data using the random key, and verifying, by the analysis system, integrity of decrypted evidence data using the signature value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a digital evidence collection system using a notarization agent according to an embodiment of the present invention;

FIG. 2 is a flow diagram showing a digital evidence collection procedure according to an embodiment of the present invention;

FIG. 3 is a flow diagram showing a digital evidence analysis procedure according to an embodiment of the present invention;

FIG. 4 is a diagram showing the detailed configuration of a notarization agent according to an embodiment of the present invention;

FIG. 5 is a diagram showing the detailed configuration of a notarization server according to an embodiment of the present invention; and

FIG. 6 is a diagram showing the detailed configuration of an evidence collection device according to an embodiment of the present invention.

### DESCRIPTION OF THE PREFERRED EMBODIMENTS

The present invention is described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

Hereinafter, preferred embodiments of the present invention will be described in detail with reference to the attached drawings.

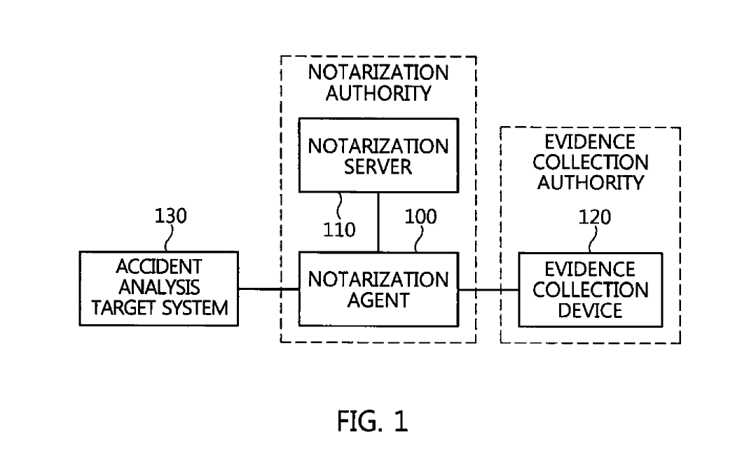

FIG. 1 is a diagram showing the configuration of a digital evidence collection system using a notarization agent according to an embodiment of the present invention.

The digital evidence collection system using a notarization agent according to the embodiment of the present invention includes a notarization agent 100, a notarization server 110, an evidence collection device 120, and an accident analysis target system 130. The notarization agent 100 may be regarded as a notarization agent apparatus.

The evidence collection device 120 may collect evidence data from the target system 130 using the notarization agent 100.

The notarization agent 100 is a medium authenticated by the notarization server 110, and is capable of securing the objectivity and integrity of evidence data that is collected later by the evidence collection device 120 because details of the evidence data collected by the evidence collection device 120 are collected by the notarization agent 100 and are stored in the notarization server 110.

The detailed configurations and operations of the notarization agent 100, the notarization server 110, and the evidence collection device 120 will be described in detail later with reference to other drawings.

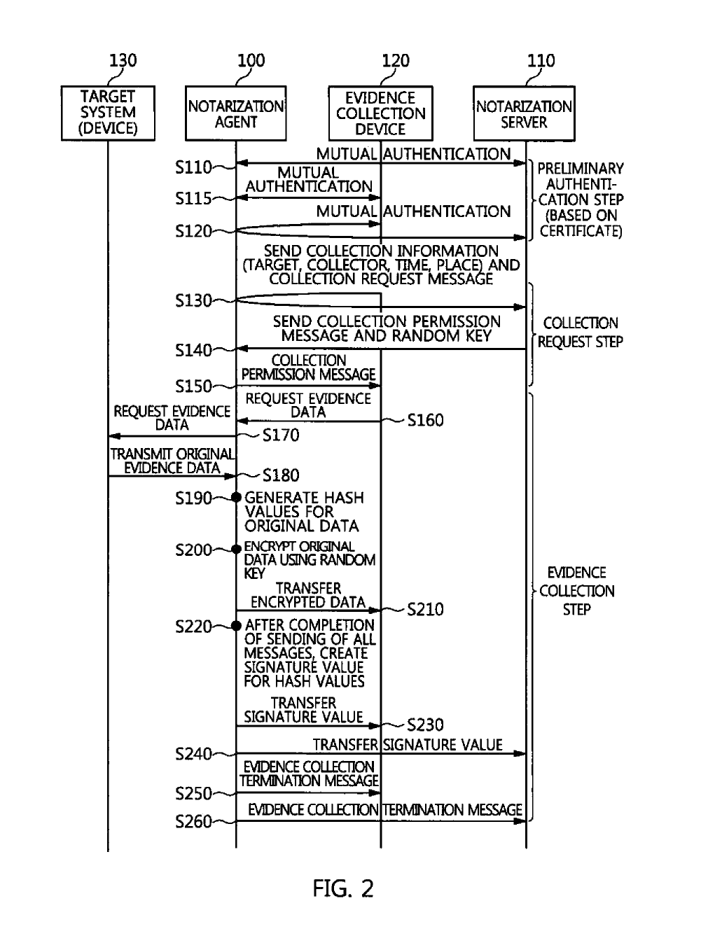

FIG. 2 is a flow diagram showing a digital evidence collection procedure according to an embodiment of the present invention.

Referring to FIG. 2, the digital evidence collection procedure according to the embodiment of the present invention includes a preliminary authentication step, a collection request step, and an evidence collection step.

At the preliminary authentication step, the notarization agent 100 and the notarization server 110 are proved to be legitimate communication entities via mutual authentication therebetween at step S110.

Further, the evidence collection device 120 is proved to be a legitimate evidence collection device 120 via mutual authentication with the notarization agent 100 at step S115.

Furthermore, the evidence collection device 120 is proved to be a legitimate evidence collection device 120 via mutual authentication with the notarization server 110 at step S120.

In this case, certificate-based authentication is used in the mutual authentication procedure, thus allowing only legitimate objects to participate in communication, and providing a non-repudiation function.

At the collection request step, the evidence collection device 120 generates unique collection information in which an evidence collection target, an evidence collection time, an evidence collection place, and an evidence collector are recorded. The generated unique collection information is transmitted to the notarization server 110 through the notarization agent 100 at the same time that a collection request message is transferred to the notarization server 110 at step S130.

The notarization server 110 stores the unique collection information, generates a random key corresponding to the unique collection information, and transfers the random key to the notarization agent 100 at step S140.

In this case, the random key denotes a randomly generated key value, which may be formed in an array of characters, numerals or special symbols.

The random key is used for the encryption of evidence data, and is transferred to an analysis tool in a subsequent analysis procedure and then used for decryption.

At the evidence collection step, the notarization agent 100 requests evidence data corresponding to the unique collection information from the target system 130 at step S170.

The target system 130 that received the evidence data request transfers original data to the notarization agent 100 at step S180.

In this case, the evidence data may be transferred with the evidence data partitioned into blocks of constant size.

The notarization agent 100 generates hash values for the respective received blocks at step S190, and encrypts the respective blocks using the received random key at step S200.

The encrypted blocks are transmitted to the evidence collection device 120, and the hash values are stored at step S210.

After all blocks have been encrypted and transmitted, a signature is created for resulting values obtained by again calculating hash values for the hash values of the respective blocks, using the private key of the notarization agent at step S220.

That is, when the entirety of the evidence data is assumed to be D, the evidence data is partitioned into blocks d₁, d₂, . . . dₙ so that the entire data can be transmitted at a time. The agent which received the block d₁ obtains a hash value h(d₁), temporarily stores the hash value, generates a block E_{RK}(d₁) encrypted using the random key, and sends the encrypted block E_{RK}(d₁) to the evidence collection device 120.

After this procedure has been completed to dₙ, hash values are again obtained for the hash values h(d₁), h(d₂), . . . h(dₙ), and a signature is created for the obtained hash values, with the result that the signature value S(h(h(d₁), h(d₂), . . . h(dₙ))) is obtained.

The notarization agent 100 transmits the created signature value both to the notarization server 110 and to the evidence collection device 120 at steps S230 and S240.

Meanwhile, original data blocks may be encrypted first, and hash values for the encrypted data blocks may be subsequently obtained.

That is, the received block d₁ is encrypted and a value of E_{RK}(d₁) is transmitted to the evidence collection device, and a hash value h(E_{RK}(d₁)) is obtained and temporarily stored. After the transmission of the encrypted blocks has been completed to dₙ, hash values are again obtained for the hash values, and a signature is created for the hash values, with the result that the signature value S(h(h(E_{RK}(d₁)), h(E_{RK}(d₂)), . . . , h(E_{RK}(dₙ)))) is obtained.

Thereafter, the notarization agent 100 generates an evidence collection termination message, sends it both to the notarization server 110 and to the evidence collection device 120, and terminates the evidence collection procedure at steps S250 and S260.

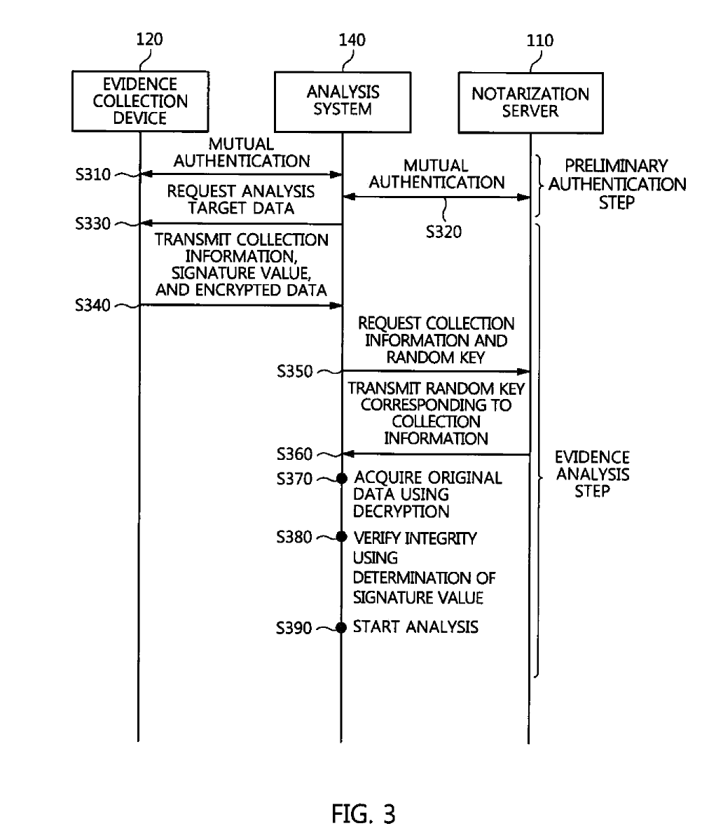

FIG. 3 is a flow diagram showing a digital evidence analysis procedure according to an embodiment of the present invention.

Referring to FIG. 3, the digital evidence analysis procedure according to the embodiment of the present invention is performed to include a preliminary authentication step and an evidence analysis step.

At the preliminary authentication step, mutual authentication is performed between the evidence collection device 120 and the analysis system 140 at step S310, and is also performed between the analysis system 140 and the notarization server 110 at step S320.

At the evidence analysis step, if the analysis system 140 requests analysis target data from the evidence collection device 120 at step S330, the evidence collection device 120 transmits stored items, that is, unique collection information, a signature value, and encrypted data, to the analysis system 140 at step S340.

The analysis system 140 transfers the unique collection information and a random key request message to the notarization server 110 at step S350, and the notarization server 110 transfers a random key corresponding to the unique collection information to the analysis system 140 at step S360.

The analysis system 140 acquires original evidence data by decrypting the encrypted evidence data using the random key at step S370, and determines, based on the original evidence data, whether the received signature value is valid at step S380.

If it is determined that the signature value created by the notarization agent is valid, the integrity of the evidence data has no problem, and thus the analysis of the evidence data starts at step S390.

Meanwhile, if the signature value has been created before encryption, the signature value is first checked before decryption, and then decryption is performed.

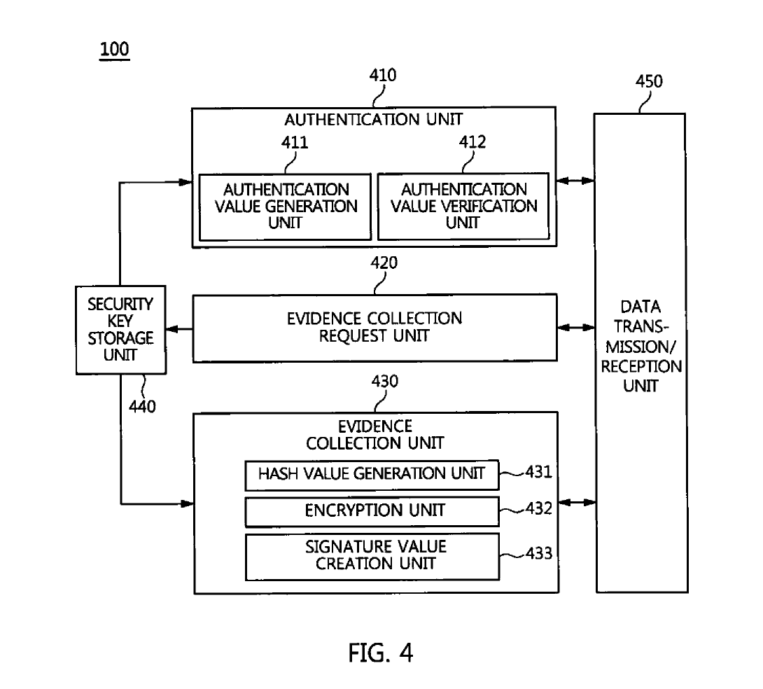

FIG. 4 is a diagram showing the detailed configuration of the notarization agent according to an embodiment of the present invention.

Referring to FIG. 4, the notarization agent 100 according to the embodiment of the present invention includes an authentication unit 410, an evidence collection request unit 420, an evidence collection unit 430, a security key storage unit 440, and a data transmission/reception unit 450.

The authentication unit 410 performs authentication via comparison with the authentication values of the evidence collection device 120 and the notarization server 110.

In this case, the authentication unit 410 takes charge of mutual authentication between the notarization agent 100 and the notarization server 110, and includes an authentication value generation unit 411 for authenticating the notarization agent 100, and an authentication value verification unit 412 for verifying the authentication of the notarization server 110.

Further, a private key of the notarization agent for generating an authentication value may be received from the security key storage unit 440 and then used.

The evidence collection request unit 420 generates an evidence collection request message requesting the permission of collection of the evidence data.

The evidence collection unit 430 collects evidence data from the evidence collection target system 130, and encrypts the evidence data.

In this case, the evidence collection unit 430 includes a hash value generation unit 431 for generating hash values of original data received from the evidence collection target system 130, an encryption unit 432 for encrypting the original evidence data, and a signature value creation unit 433 for creating a signature value using the hash values.

Here, the encryption unit 432 may receive the random key from the security key storage unit 440 and encrypt the original evidence data using the random key.

The security key storage unit 440 stores the private key for authentication and the random key received from the notarization server.

The data transmission/reception unit 450 transmits and receives data to and from the notarization server 110, the evidence collection device 120, and the target system 130.

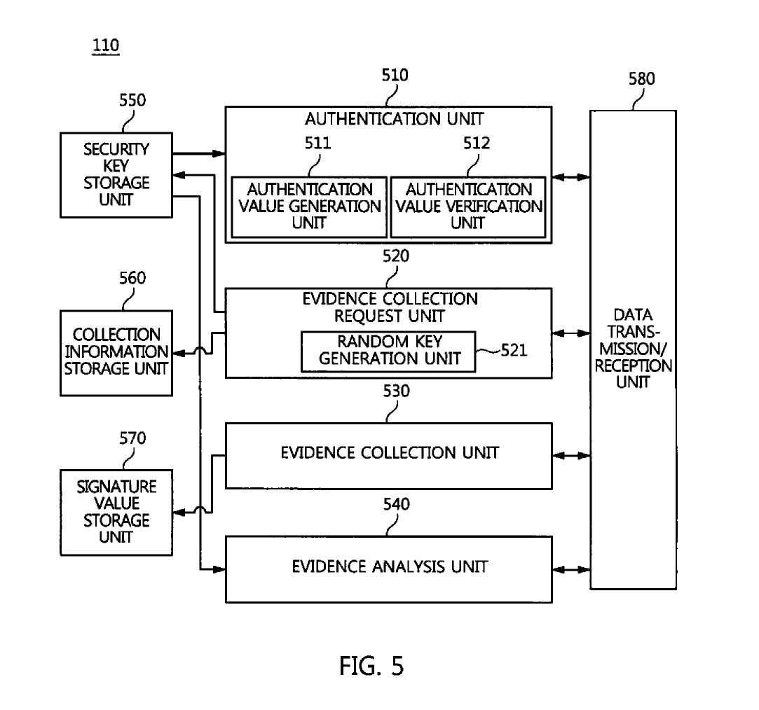

FIG. 5 is a diagram showing the detailed configuration of the notarization server according to an embodiment of the present invention.

Referring to FIG. 5, the notarization server 110 according to the embodiment of the present invention includes an authentication unit 510, an evidence collection request unit 520, an evidence collection unit 530, an evidence analysis unit 540, a security key storage unit 550, a collection information storage unit 560, a signature value storage unit 570, and a data transmission/reception unit 580.

The authentication unit 510 performs authentication via comparison with the authentication values of the notarization agent 100, the evidence collection device 120, and the analysis system 140.

The authentication unit 510 takes charge of mutual authentication with the notarization agent 100, the evidence collection device 120, and the analysis system 140. The authentication unit 510 includes an authentication value generation unit 511 for generating an authentication value for the notarization server 110 so as to perform mutual authentication with the notarization agent 100, the evidence collection device 120, and the analysis system 140, and an authentication value verification unit 512 for verifying the authentication of the notarization agent 100, the evidence collection device 120, and the analysis system 140.

In this case, the private key of the notarization server required to generate the authentication value may be received from the security key storage unit 550 and then used.

The evidence collection request unit 520 may check an evidence collection request message requesting the permission of collection of evidence data received from the notarization agent 100, and generate a collection permission message that permits evidence collection.

In this regard, the evidence collection request unit 520 may include a random key generation unit 521 for generating a random key corresponding to unique collection information in which an evidence collection target, an evidence collection time, an evidence collection place, and an evidence collector are recorded.

The evidence collection unit 530 may collect signature values from the notarization agent 100.

The evidence analysis unit 540 may receive unique collection information from the analysis system 140, analyze the received unique collection information, and provide a random key matching the unique collection information to the analysis system 140.

The security key storage unit 550 may store the private key of the notarization server 110 and the generated random key.

The collection information storage unit 560 may store the unique collection information transmitted from the evidence collection device 120.

The signature value storage unit 570 may store the signature value transmitted from the notarization agent 100.

The data transmission/reception unit 580 transmits and receives data to and from the notarization agent 100 and the target system 130.

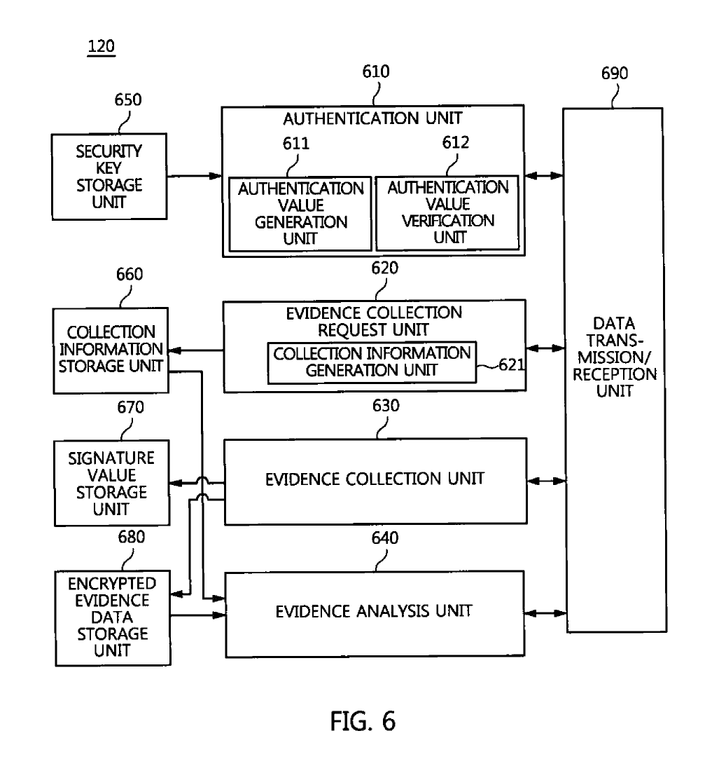

FIG. 6 is a diagram showing the detailed configuration of the evidence collection device according to an embodiment of the present invention.

Referring to FIG. 6, the evidence collection device 120 according to an embodiment of the present invention includes an authentication unit 610, an evidence collection request unit 620, an evidence collection unit 630, an evidence analysis unit 640, a security key storage unit 650, a collection information storage unit 660, a signature value storage unit 670, an encrypted evidence data storage unit 680, and a data transmission/reception unit 690.

The authentication unit 610 performs authentication via comparison with the authentication values of the notarization agent 100, the notarization server 110, and the analysis system 140.

The authentication unit 610 takes charge of mutual authentication with the notarization agent 100, the notarization server 110, and the analysis system 140, and includes an authentication value generation unit 611 for authenticating the evidence collection device 120, and an authentication value verification unit 612 for verifying the authentication of the notarization server 110 and the analysis system 140.

The evidence collection request unit 620 requests notarization agent 100 to collect evidence data, and includes a collection information generation unit 621 for generating unique collection information in which an evidence collection target, an evidence collection time, an evidence collection place, and an evidence collector are recorded.

The evidence collection unit 630 collects data encrypted by the notarization agent 100 and signature values created by the notarization agent 100.

The evidence analysis unit 640 may receive an analysis target data request from the analysis system 140, and provide unique collection information, a signature value, and encrypted evidence data corresponding to the analysis target data to the analysis system 140.

The security key storage unit 650 may store the private key of the evidence collection device 120.

The collection information storage unit 660 may store the unique collection information generated by the collection information generation unit 621.

The signature value storage unit 670 may store the signature value transmitted from the notarization agent 100.

The encrypted evidence data storage unit 680 may store the encrypted evidence data transmitted from the notarization agent 100.

The data transmission/reception unit 690 may transmit and receive data to and from the notarization agent 100 and the analysis system 140.

In accordance with the embodiments of the present invention, a notarization agent is disposed between an evidence collection device and a target system, thus blocking possibility to forge or falsify original digital evidence data.

Further, the notarization agent creates a signature value in the state in which original data is collected, thus providing integrity from the time at which evidence data is collected, without generating an integrity verification value after the evidence data has been collected.

Furthermore, after the notarization agent has collected original data, evidence data is encrypted using a random key provided by the notarization server and is provided to the evidence collection device, so that confidentiality can be continuously provided until an analysis step, and access to data can be thoroughly blocked, except for access by an analysis system which is authenticated by the notarization server and which has transferred the random key.

Although the configuration of the present invention has been described with reference to the preferred embodiments of the present invention, those skilled in the art will appreciate that the present invention may be embodied in other detailed forms, without departing from the scope and spirit of the invention. Therefore, the above-described embodiments should be understood to be exemplary rather than restrictive in all aspects. The scope of the present invention is defined by the accompanying claims rather than the detailed description of the invention. Furthermore, all changes or modifications derived from the scope and equivalents of the claims should be interpreted as being included in the scope of the present invention.

What is claimed is:

1. A digital evidence collection method, comprising:
sending, by an evidence collection device, an evidence collection request message requesting permission of evidence collection to a notarization server through a notarization agent;
sending, by the notarization server, a collection permission message permitting evidence collection to the evidence collection device through the notarization agent;
requesting, by the evidence collection device, evidence data from an evidence collection target system through the notarization agent;
transmitting, by the evidence collection target system, the evidence data to the notarization agent; and
encrypting, by the notarization agent, the evidence data and transferring, by the notarization agent, encrypted evidence data to the evidence collection device.

2. The digital evidence collection method of claim 1, wherein:
the evidence collection request message includes unique collection information of the evidence data, and
the notarization server generates a random key for the unique collection information, and transfers the random key together with the collection permission message to the notarization agent.

3. The digital evidence collection method of claim 2, wherein the notarization agent encrypts the evidence data using the random key.

4. The digital evidence collection method of claim 1, wherein:
the evidence collection target system partitions the evidence data into data blocks of preset size and transmits the data blocks to the notarization agent, and
the notarization agent generates primary hash values for the data blocks and stores the hash values.

5. The digital evidence collection method of claim 4, wherein the notarization agent transfers the encrypted evidence data to the evidence collection device, generates secondary hash values for the primary hash values, creates a signature value for the secondary hash values, and stores the signature value.

6. The digital evidence collection method of claim 1, wherein:
the evidence collection target system partitions the evidence data into data blocks of preset size and transmits the data blocks to the notarization agent, and
the notarization agent encrypts the data blocks, transmits the encrypted data blocks to the evidence collection device, generates primary hash values for the encrypted data blocks, and stores the primary hash values.

7. The digital evidence collection method of claim 6, wherein the notarization agent transfers the encrypted evidence data to the evidence collection device, generates secondary hash values for the primary hash values, creates a signature value for the secondary hash values, and stores the signature value.

8. The digital evidence collection method of claim 1, further comprising, before sending the evidence collection request message requesting permission of evidence collection, performing authentication between the evidence collection device, the notarization agent, and the notarization server.

9. A notarization agent, comprising:
an authentication unit for performing authentication via comparison with authentication values of an evidence collection device and a notarization server;
an evidence collection request unit for generating an evidence collection request message requesting permission of collection of evidence data; and
an evidence collection unit for collecting evidence data from an evidence collection target system and encrypting the evidence data.

10. The notarization agent of claim 9, wherein:
the evidence collection request message includes unique collection information of the evidence data, and
the evidence collection unit receives a random key for the unique collection information from the notarization server, and encrypts the evidence data using the random key.

11. The notarization agent of claim 10, wherein the evidence collection unit partitions the evidence data into data blocks of preset size, collects the data blocks, generates primary hash values for the data blocks, and stores the primary hash values.

12. The notarization agent of claim 11, wherein the evidence collection unit transfers the encrypted evidence data to the evidence collection device, generates secondary hash values for the primary hash values, creates a signature value for the secondary hash values, and stores the signature value.

13. The notarization agent of claim 11, wherein the evidence collection unit encrypts the data blocks, transmits encrypted data blocks to the evidence collection device, generates primary hash values for the encrypted data blocks, and stores the primary hash values.

14. The notarization agent of claim 13, wherein the evidence collection unit transfers the encrypted evidence data to the evidence collection device, generates secondary hash values for the primary hash values, creates a signature value for the secondary hash values, and stores the signature value.

15. The notarization agent of claim 9, further comprising a security key storage unit for storing a private key required to generate an authentication value,
wherein the authentication unit generates the authentication value using the private key, compares the authentication value with an authentication value of the notarization server or the evidence collection device, and then performs authentication.

16. A digital evidence analysis method, comprising:
requesting, by an analysis system, analysis target data from an evidence collection device;
transmitting, by the evidence collection device, unique collection information, a signature value, and encrypted evidence data to the analysis system;
transferring, by the analysis system, the unique collection information to a notarization server;
transferring, by the notarization sever, a random key corresponding to the unique collection information to the analysis system;
decrypting, by the analysis system, the encrypted evidence data using the random key; and
verifying, by the analysis system, integrity of decrypted evidence data using the signature value.
